(19) United States
(12) Patent Application Publication
(10) Pub. No.: US 2011/0281965 A1
(43) Pub. Date: Nov. 17, 2011

(54) POLYURETHANE CASTING COMPOUNDS

(75) Inventors: Hans-Josef Laas, Odenthal (DE); Jens Krause, Mours Saint Eusebe (FR); Reinhard Halpaap, (US); Christian Wamprecht, Neuss (DE); Dorota Greszta-Franz, Solingen (DE)

(73) Assignee: Bayer MateialScience AG, Leverkusen (DE)

(21) Appl. No.: 13/145,486

(22) PCT Filed: Jan. 13, 2010
(86) PCT No.: PCT/EP2010/000126

§ 371 Date: Jul. 20, 2011

(30) Foreign Application Priority Data
Jan. 22, 2009 (DE) 102009005711.0

(51) Int. Cl. C08G 18/75; C08G 18/50; C08G 18/73; C08J 9/00; C08G 18/44; C08G 18/42; C08G 18/32; C08G 18/79; C08G 18/48

(52) U.S. Cl. 521/137; 521/160; 521/159

(57) ABSTRACT

The invention relates to the use of polyurethane casting compounds for producing light-resistant compact or expanded polyurethane or polyurethane urea bodies that are characterized by exceptionally good mechanical and visual properties and particularly have a very high heat shape retention.

The production of lightfast polyurethane or polyurethane-urea elastomers using aliphatic and/or cycloaliphatic polyisocyanates is known.

There is at present a growing market interest in rigid, light-resistant and weather-resistant polyurethane and polyurethane-urea compositions for a variety of different applications, for example as a substitute for mineral glass for the production of window panes for vehicle and aircraft construction, for the production of optical lenses and spectacle lenses, or as potting compounds for electronic or optoelectronic components.

The production of rigid lightfast polyurethane or polyurethane-urea elastomers has already been described many times. The aliphatic and/or cycloaliphatic diisocyanates available in industry, such as for example 1,6-diisocyanatohexane (HDI), 1-isocyanato-3,3,5-trimethyl-5-isocyanatomethylcyclohexane (isophorone diisocyanate, IPDI) and/or 2,4′- and/or 4,4′-diisocyanatodicyclohexylmethane (H₁₂-MDI) or oligomeric derivatives of these diisocyanates, are generally used as polyisocyanate components.

WO 1996/023827 describes transparent, highly rigid and impact-resistant polyurethane-urea compositions produced by reacting semi-prepolymers based on 4,4′-diisocyanatodicyclohexylmethane with substituted 4,4′-methylene-bis-anilines which are suitable for example for the production of car windows or safety glass.

An improved process for producing such polyurethane-urea compositions suitable as a glass substitute, wherein isocyanate-functional semi-prepolymers are cured using diethyl toluoylene diamine (DETDA) as an aromatic diamine, is known from WO 2003/072624.

Transparent, rigid polyurethane-urea compositions having good heat resistance, which can be used as a material for spectacle lenses, can be obtained in a similar way according to the teaching of WO 2000/014137 from polyurethane prepolymers based on aliphatic and/or cycloaliphatic diisocyanates and at least one aromatic diamine or according to WO 2004/076518 by curing isocyanate prepolymers with crosslinker blends consisting of hydroxy-functional polyurethane prepolymers and aromatic diamines.

Although the use of aromatic diamines as chain extenders makes it possible to produce polyurethane-urea compositions by the above method having the desired hardness and heat resistance values, it also leads to an inadequate colour stability. The yellowing of such compositions can be suppressed for a limited time by adding large amounts of UV stabilisers and antioxidants, as described for example in WO 2008/033659, but it inevitably occurs sooner or later.

The production of compact, transparent polyurethane compositions which are free from urea groups and yet are suitable as glass substitutes is provided by EP-A 0 943 637. In order to be able to achieve adequately high hardness values, however, the use of very specific highly functional polyol mixtures is specified in this process.

Common to all the cited processes for producing lightfast, rigid polyurethane and polyurethane-urea compositions or articles obtainable from them, however, is the considerable disadvantage that they work with large amounts of low-molecular-weight monomeric diisocyanates, which are classed as toxic materials and in some cases exhibit a considerable vapour pressure. For occupational health reasons the processing of these monomeric diisocyanates requires a high level of safety precautions to be taken. There is also the possibility, particularly if a polyisocyanate excess is used, as proposed for example in WO 2008/033659, of unreacted monomeric diisocyanate remaining in the manufactured moulding, e.g. a spectacle lens, for some time and slowly evaporating from it.

There has been no shortage of attempts to provide polyurethane compositions for the production of lightfast rigid moulded articles on the basis of low-monomer, higher-molecular-weight, non-toxic polyisocyanates, in particular those based on the known aliphatic polyisocyanates having a biuret, isocyanurate or uretdione structure.

However, even when combined with the specific high-functionality polyol blends described in EP-B 0 943 637, the polyisocyanates which are liquid in solvent-free form at processing temperature, based on linear-aliphatic diisocyanates, such as for example HDI trimers, lead only to products having a relatively low glass transition temperature (T_{g}) and correspondingly low heat resistance, as can be inferred from Example 1 of this publication.

By contrast, low-monomer polyisocyanates based on cycloaliphatic diisocyanates are solid at processing temperature, having melting points generally in the range from 80° to 120° C. Therefore their use as a crosslinker component for lightfast polyurethane potting compounds was hitherto only ever possible by incorporating large amounts of monomeric diisocyanates as reactive thinners (see for example DE-A 2 900 031), and this in turn is associated with the occupational health disadvantages discussed above.

The object of the present invention was to provide novel rigid, light-resistant and weather-resistant polyurethane and polyurethane-urea compositions which do not present the disadvantages of the known systems. The novel polyurethane compositions should be based on non-toxic raw materials and should be able to be processed by conventional methods, for example by simple casting by hand or by means of suitable machines, for example by the RIM process, to produce highly crosslinked, heat-resistant moulded articles.

This object was achieved by the provision of the polyurethanes and polyurethane ureas described in more detail below.

The invention described in more detail below is based on the surprising observation that lightfast compact or foamed polyurethane or polyurethane-urea articles can be produced using solvent-free blends known per se of low-viscosity HDI polyisocyanates with trimers of cycloaliphatic diisocyanates which are characterised by exceptionally good mechanical and optical properties and in particular have a very high heat resistance.

Such solutions of inherently solid or extremely highly viscous cycloaliphatic polyisocyanurates in low-viscosity HDI polyisocyanates are known for example from EP-A 0 693 512 as crosslinker components for solvent-free polyols for the production of energy-elastic, highly abrasion-resistant coatings, in particular for sealing balconies or roofs. Although there is a general reference in this publication to the fact that such systems are also suitable for producing lightfast, rigid potting compounds, the person skilled in the art would be unable to glean any further, specific information regarding the particular suitability of such polyisocyanate blends as starting components for the production of lightfast compact and foamed polyurethane or polyurethane-urea articles having high heat resistance or the excellent optical properties of polyurethane moulded articles obtainable in this way.

Solvent-free polyisocyanate blends consisting of HDI polyisocyanates, preferably HDI trimers, and polyisocyanates based on cycloaliphatic diisocyanates have also already been described in EP-A 1 484 350 as crosslinkers for very specific solvent-free polyester polyols having a functionality of less than 3 in solvent-free coating compounds. In these two-component systems, which are used in particular for the coating of decorative parts with low thermal yellowing, for example those in a burl wood effect, as are increasingly being used nowadays in the automotive or furniture industry, the use of the specific polyisocyanate blends leads to glass transition temperatures (Tg) of over 70° C., thus allowing the coated components to be re-polished if necessary. Although reaction injection moulding (RIM) in closed moulds is also mentioned in EP-A 1 484 350 as a preferred application method for the systems described, the publication contains no specific description of the production of solid compact or even foamed mouldings, dealing exclusively with the coating of suitable substrates. Here too there is for example no mention of the high optical quality and excellent heat resistance of the polyurethane or polyurethane-urea compositions obtainable according to the invention. Indeed, from the specific comparative examples published in the document the person skilled in the art would even assume that the low-monomer polyisocyanate blends described cure to form low-yellowing, rigid and transparent polyurethanes only in combination with very specific, ether group-free polyester polyols based on aromatic carboxylic acids. Our own experiments show that the comparative tests described in EP-A 1 484 350, which lead to soft, matt or hazy paint films, are unrepresentative, isolated cases. As is described in more detail below, the polyisocyanate blends suitable for use as crosslinkers in polyurethane or polyurethane-urea compositions can be combined without difficulty with many different reaction partners, even highly functional examples, including ether group-containing polyols or aromatic-free polyester polyols, to form transparently curing rigid systems having high optical brilliance.

The present invention provides the use of solvent-free, low-monomer polyisocyanate components A), which at 23° C. have a viscosity of 2000 to 100,000 mPas, an isocyanate group content of 13 to 23 wt. % and an average isocyanate functionality of at least 2.5 and which consist of 30 to 95 wt. % of at least one polyisocyanate a-1) based on hexamethylene diisocyanate having an NCO content of 16 to 24 wt. % and 20 to 60 wt. % of at least one polyisocyanate a-2) based on cycloaliphatic diisocyanates having an NCO content of 10 to 22 wt. %, for the production of lightfast compact or foamed polyurethane and/or polyurea articles.

The invention also provides a process for producing lightfast polyurethane and/or polyurea articles by the solvent-free reaction of
A) a low-monomer polyisocyanate component, which at 23° C. has a viscosity of 2000 to 100,000 mPas, an isocyanate group content of 13 to 23 wt. % and an average isocyanate functionality of at least 2.5 and which consists of 30 to 95 wt. % of at least one polyisocyanate a-1) based on hexamethylene diisocyanate having an NCO content of 16 to 24 wt. % and 5 to 70 wt. % of at least one polyisocyanate a-2) based on cycloaliphatic diisocyanates having an NCO content of 10 to 22 wt. %,
with
B) reaction partners having an average functionality of 2.0 to 6.0 which are reactive to isocyanate groups, and optionally with incorporation of
C) further auxiliary agents and additives,
   whilst maintaining an equivalents ratio of isocyanate groups to isocyanate-reactive groups of 0.5:1 to 2.0:1.

The invention finally also provides the use of lightfast polyurethane and/or polyurea compositions obtainable in this way for the production of transparent compact or foamed mouldings.

The polyisocyanate components A) used to produce the novel lightfast polyurethane or polyurea compositions are solvent-free mixtures comprising 30 to 95 wt. % of at least one polyisocyanate a-1) based on HDI and 5 to 70 wt. % of at least one polyisocyanate a-2) based on cycloaliphatic diisocyanates.

The polyisocyanates a-1) are the HDI derivatives known per se containing uretdione, isocyanurate, iminooxadiazinedione, urethane, allophanate, biuret and/or oxadiazinetrione groups which at 23° C. have a viscosity of 80 to 12,000 mPas, an isocyanate group content of 16 to 25 wt. %, a monomeric HDI content of less than 0.5 wt. % and an average isocyanate functionality of at least 2.0.

These are described by way of example in Laas et al., J. Prakt. Chem. 336, 1994, 185-200, DE-A 1 670 666, DE-A 3 700 209, DE-A 3 900 053, EP-A 0 330 966, EP-A 0 336 205, EP-A 0 339 396 and EP-A 0 798 299.

The polyisocyanates of component a-1) are preferably HDI-based polyisocyanates of the aforementioned type having a uretdione, allophanate, isocyanurate and/or iminooxadiazinetrione structure which at 23° C. have a viscosity of 100 to 1600 mPas and an isocyanate group content of 18 to 24.5 wt. %.

The polyisocyanates of component a-1) are particularly preferably HDI polyisocyanates of the aforementioned type having isocyanurate groups and/or iminooxadiazinedione groups, with a viscosity at 23° C. of 300 to 1500 mPas and an isocyanate group content of 20 to 24 wt. %.

The polyisocyanates of component a-2) are the polyisocyanates based on cycloaliphatic diisocyanates known per se containing allophanate, biuret, isocyanurate, uretdione and/or urethane groups which at 23° C. are in solid form or have a viscosity of over 200,000 mPas and whose content of isocyanate groups is 10 to 25 wt. % and that of monomeric diisocyanates less than 0.5 wt. %. Suitable cycloaliphatic starting diisocyanates for the production of the polyisocyanate components a-2) are for example 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, IPDI, 1-isocyanato-1-methyl-4(3)-isocyanatomethylcyclohexane, and 4,4′-diisocyanatodicyclohexylmethane, 1,3- and 1,4-bis(isocyanatomethyl)cyclohexane, 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl) and any mixtures of these diisocyanates.

The polyisocyanates of component a-2) are preferably compounds of the aforementioned type with isocyanurate groups which are known per se and are described by way of example in Laas et al., J. Prakt. Chem. 336, 1994, 185-200, EP-A 0 003 765, EP-A 0 017 998, EP-A 0 193 828, DE-A 1 934 763 and DE-A 2 644 684.

The polyisocyanates of component a-2) are particularly preferably those of the aforementioned type based on IPDI and/or 2,4′- and 4,4′-diisocyanatodicyclohexylmethane having an isocyanate group content of 13 to 19 wt. %.

Most particularly preferred polyisocyanates of component a-2) are those of the aforementioned type based on IPDI having an isocyanate group content of 15 to 18 wt. %.

Both the HDI used for production of the polyisocyanate component a-1) and the cited cycloaliphatic starting diisocyanates for the polyisocyanate components a-2) can be produced by any method, for example by phosgenation or in a phosgene-free manner, for example by urethane cleavage.

The polyisocyanate component A) contained in the compositions which can be produced or used according to the invention is produced by simply mixing the individual components a-1) and a-2) in the aforementioned proportions, optionally preheated to temperatures of 30 to 240°, whilst preferably maintaining a weight ratio of a-1): a-2) of 90:10 to 35:65, particularly preferably 80:20 to 40:60, and then stirring the mixture until it is homogeneous, the temperature of the mixture being held at a temperature of 30 to 140° C., preferably 40 to 100° C., optionally by heating it further.

In a preferred embodiment, in the production of the polyisocyanate component A) the polyisocyanate component a-2), which is highly viscous or solid at 23° C., after being produced by catalytic trimerisation of cycloaliphatic diisocyanates following monomer separation by film distillation is immediately introduced whilst still hot, for example at temperatures of 100 to 240° C., into the polyisocyanate component a-1), which has likewise been heated, and stirred, optionally with further heating, until the mixture is homogeneous.

In another likewise preferred embodiment, in the production of the polyisocyanate component A) the polyisocyanate component a-1) is stirred into the crude solution obtained during production of the polyisocyanate component a-2) on completion of the trimerisation reaction prior to film distillation, and the excess monomeric cycloaliphatic diisocyanates are only separated off afterwards.

Irrespective of the manner in which they are produced, the polyisocyanate components A) are generally obtained as clear, practically colourless resins, whose viscosity at 23° C. is preferably 6000 to 60,000 mPas, particularly preferably 8000 to 50,000 mPas, whose isocyanate group content is preferably 15 to 22 wt. %, particularly preferably 16 to 21 wt. %, and whose average isocyanate functionality is preferably 2.8 to 5.0, particularly preferably 3.0 to 4.5. The polyisocyanate component A) is low in residual monomers, since it has a residual content of monomeric diisocyanates (total of monomeric HDI and monomeric cycloaliphatic diisocyanates) of less than 1 wt. %, preferably less than 0.5 wt. %, particularly preferably less than 0.3 wt. %.

For the production of the lightfast polyurethane and/or polyurea compositions according to the invention, the polyisocyanate components A) described above are reacted with any solvent-free isocyanate group-reactive reaction partners B) having an average functionality in the sense of the isocyanate addition reaction of 2.0 to 6.0, preferably 2.5 to 4.0, particularly preferably 2.5 to 3.5.

These are in particular the conventional polyether polyols, polyester polyols, polyether polyester polyols, polythioether polyols, polymer-modified polyether polyols, graft polyether polyols, in particular those based on styrene and/or acrylonitrile, polyether polyamines, hydroxyl group-containing polyacetals and/or hydroxyl group-containing aliphatic polycarbonates known from polyurethane chemistry, which conventionally have a molecular weight of 106 to 12000, preferably 250 to 8000. A broad overview of suitable reaction partners B) can be found for example in N. Adam et al.: “Polyurethanes”, Ullmann's Encyclopedia of Industrial Chemistry, Electronic Release, 7th ed., chap. 3.2-3.4, Wiley-VCH, Weinheim 2005.

Suitable polyether polyols B) are for example those of the type mentioned in DE-A 2 622 951, column 6, line 65—column 7, line 47, or EP-A 0 978 523 page 4, line 45 to page 5, line 14, provided that they meet the aforementioned requirements regarding functionality and molecular weight, such polyether polyols being preferred in which primary hydroxyl groups make up at least 50%, preferably at least 80%, of the hydroxyl groups. Particularly preferred polyether polyols B) are addition products of ethylene oxide and/or propylene oxide with glycerol, trimethylolpropane, ethylenediamine and/or pentaerythritol.

Suitable polyester polyols B) are for example those of the type mentioned in EP-A 0 978 523 page 5, lines 17 to 47 or EP-A 0 659 792 page 6, lines 8 to 19, provided that they meet the aforementioned requirements, preferably those having a hydroxyl value of 20 to 650 mg KOH/g.

Suitable polythiopolyols B) are for example the known condensation products of thiodiglycol with itself or with other glycols, dicarboxylic acids, formaldehyde, aminocarboxylic acids and/or amino alcohols. Depending on the type of mixed components used, they are polythio-mixed ether polyols, polythioether ester polyols or polythioether ester amide polyols.

Polyacetal polyols suitable as component B) are for example the known reaction products of simple glycols, such as for example diethylene glycol, triethylene glycol, 4,4′-dioxethoxy diphenyl dimethylmethane (adduct of 2 mol ethylene oxide with bisphenol A) or hexanediol, with formaldehyde, or polyacetals produced by polycondensation of cyclic acetals, such as for example trioxane.

Amino polyethers or mixtures of aminopolyethers are also very suitable as component B), i.e. polyethers having isocyanate group-reactive groups made up of at least 50 equivalents %, preferably at least 80 equivalents %, of primary and/or secondary, aromatically or aliphatically bonded amino groups, the remainder being primary and/or secondary, aliphatically bonded hydroxyl groups. Suitable amino polyethers of this type are for example the compounds mentioned in EP-A 0 081 701, column 4, line 26 to column 5, line 40. Likewise suitable as starting component B) are amino-functional polyether urethanes or ureas, such as can be produced for example by the method described in DE-A 2 948 419 by hydrolysing isocyanate-functional polyether prepolymers, or polyesters in the aforementioned molecular weight range containing amino groups.

Other suitable isocyanate group-reactive components B) are for example also the special polyols described in EP-A 0 689 556 and EP-A 0 937 110, which are obtainable for example by reacting epoxidised fatty acid esters with aliphatic or aromatic polyols with epoxide ring opening.

Hydroxyl group-containing polybutadienes can optionally also be used as component B).

Polymercaptans, in other words polythio compounds, for example simple alkanethiols, such as for example methanedithiol, 1,2-ethanedithiol, 1,1-propanedithiol, 1,2-propanedithiol, 1,3-propanedithiol, 2,2-propanedithiol, 1,4-butanedithiol, 2,3-butanedithiol, 1,5-pentanedithiol, 1,6-hexanedithiol, 1,2,3-propanetrithiol, 1,1-cyclohexanedithiol, 1,2-cyclohexanedithiol, 2,2-dimethylpropane-1,3-dithiol, 3,4-dimethoxybutane-1,2-dithiol and 2-methylcyclohexane-2,3-dithiol, polythiols containing thioether groups, such as for example 2,4-dimercaptomethyl-1,5-dimercapto-3-thiapentane, 4-mercaptomethyl-1,8-dimercapto-3,6-dithiaoctane, 4,8-dimercaptomethyl-1,1′-dimercapto-3,6,9-trithiaundecane, 4,7-dimercaptomethyl-1,1′-dimercapto-3,6,9-trithiaundecane, 5,7-dimercaptomethyl-1,1′-dimercapto-3,6,9-trithiaundecane, 4,5-bis(mercaptoethylthio)-1,10-dimercapto-3,8-dithiadecane, tetrakis(mercaptomethyl)methane, 1,1,3,3-tetrakis(mercaptomethylthio)propane, 1,1,5,5-tetrakis(mercaptomethylthio)-3-thiapentane, 1,1,6,6-tetrakis(mercaptomethylthio)-3,4-dithiahexane, 2-mercaptoethylthio-1,3-dimercaptopropane, 2,3-bis(mercaptoethylthio)-1-mercaptopropane, 2,2-bis(mercaptomethyl)-1,3-dimercaptopropane, bis(mercaptomethyl)sulfide, bis(mercaptomethyl)disulfide, bis(mercaptoethyl)sulfide, bis(mercaptoethyl)disulfide, bis(mercaptopropyl)sulfide, bis(mercaptopropyl)disulfide, bis(mercaptomethylthio)methane, tris(mercaptomethylthio)methane, bis(mercaptoethylthio)methane, tris(mercaptoethylthio)methane, bis(mercaptopropylthio)methane, 1,2-bis(mercaptomethylthio)ethane, 1,2-bis(mercaptoethylthio)ethane, 2-mercaptoethylthio)ethane, 1,3-bis(mercaptomethylthio)propane, 1,3-bis(mercaptopropylthio)propane, 1,2,3-tris(mercaptomethylthio)propane, 1,2,3-tris(mercaptoethylthio)propane, 1,2,3-tris(mercaptopropylthio)propane, tetrakis(mercaptomethylthio)methane, tetrakis(mercaptoethylthiomethyl)methane, tetrakis(mercaptopropylthiomethyl)methane, 2,5-dimercapto-1,4-dithiane, 2,5-bis(mercaptomethyl)-1,4-dithiane and oligomers thereof obtainable in accordance with JP-A 07 118 263, 1,5-bis(mercaptopropyl)-1,4-dithiane, 1,5-bis(2-mercaptoethylthiomethyl)-1,4-dithiane, 2-mercaptomethyl-6-mercapto-1,4-dithiacycloheptane, 2,4,6-trimercapto-1,3,5-trithiane, 2,4,6-trimercaptomethyl-1,3,5-trithiane and 2-(3-bis(mercaptomethyl)-2-thiapropyl)-1,3-dithiolane, polyester thiols, such as for example ethylene glycol-bis(2-mercaptoacetate), ethylene glycol-bis(3-mercaptopropionate), diethylene glycol(2-mercaptoacetate), diethylene glycol(3-mercaptopropionate), 2,3-dimercapto-1-propanol(3-mercaptopropionate), 3-mercapto-1,2-propanediol-bis(2-mercaptoacetate), 3-mercapto-1,2-propanediol-bis(3-mercaptopropionate), trimethylolpropane-tris(2-mercaptoacetate), trimethylolpropane-tris(3-mercaptopropionate), trimethylolethane-tris(2-mercaptoacetate), trimethylolethane-tris(3-mercaptopropionate), pentaerythritol-tetrakis(2-mercaptoacetate), pentaerythritol-tetrakis(3-mercaptopropionate), glycerol-tris(2-mercaptoacetate), glycerol-tris(3-mercaptopropionate), 1,4-cyclohexanediol-bis(2-mercaptoacetate), 1,4-cyclohexanediol-bis(3-mercaptopropionate), hydroxymethyl sulfide-bis(2-mercaptoacetate), hydroxymethyl sulfide-bis(3-mercaptopropionate), hydroxyethyl sulfide (2-mercaptoacetate), hydroxyethyl sulfide (3-mercaptopropionate), hydroxymethyl disulfide (2-mercaptoacetate), hydroxymethyl disulfide (3-mercaptopropionate), (2-mercaptoethyl ester) thioglycolate and bis(2-mercaptoethyl ester) thiodipropionate as well as aromatic thio compounds, such as for example 1,2-dimercaptobenzene, 1,3-dimercaptobenzene, 1,4-dimercaptobenzene, 1,2-bis(mercaptomethyl)benzene, 1,4-bis(mercaptomethyl)benzene, 1,2-bis(mercaptoethyl)benzene, 1,4-bis(mercaptoethyl)benzene, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(mercaptoethyl)benzene, 1,3,5-tris(mercaptoethyl)benzene, 1,2,4-tris(mercaptoethyl)benzene, 2,5-toluenedithiol, 3,4-toluenedithiol, 1,4-naphthalenedithiol, 1,5-naphthalenedithiol, 2,6-naphthalenedithiol, 2,7-naphthalenedithiol, 1,2,3,4-tetramercaptobenzene, 1,2,3,5-tetramercaptobenzene, 1,2,4,5-tetramercaptobenzene, 1,2,3,4-tetrakis(mercaptomethyl)benzene, 1,2,3,5-tetrakis(mercaptomethyl)benzene, 1,2,4,5-tetrakis(mercaptomethyl)benzene, 1,2,3,4-tetrakis(mercaptoethyl)benzene, 1,2,3,5-tetrakis(mercaptoethyl)benzene, 1,2,4,5-tetrakis(mercaptoethyl)benzene, 2,2′-dimercaptobiphenyl and 4,4′-dimercaptobiphenyl, are particularly suitable as isocyanate group-reactive components B) for the production of articles from polyurethane and/or polyurea compositions having a particularly high refraction of light.

Preferred polythio compounds B) are polythioether thiols and polyester thiols of the cited type. Particularly preferred polythio compounds B) are 4-mercaptomethyl-1,8-dimercapto-3,6-dithiaoctane, 2,5-bismercaptomethyl-1,4-dithiane, 1,1,3,3-tetrakis(mercaptomethylthio)propane, 5,7-dimercaptomethyl-1,1′-dimercapto-3,6,9-trithiaundecane, 4,7-dimercaptomethyl-1,1′-dimercapto-3,6,9-trithiaundecane, 4,8-dimercaptomethyl-1,1′-dimercapto-3,6,9-trithiaundecane, trimethylolpropane-tris(3-mercaptopropionate), trimethylolethane-tris(2-mercaptoacetate), pentaerythritol-tetrakis(2-mercaptoacetate) and pentaerythritol-tetrakis(3-mercaptopropionate).

Sulfur-containing hydroxyl compounds are moreover also suitable as isocyanate group-reactive components B). Simple mercapto alcohols, such as for example 2-mercaptoethanol, 3-mercaptopropanol, 1,3-dimercapto-2-propanol, 2,3-dimercaptopropanol and dithioerythritol, alcohols containing thioether structures, such as for example di(2-hydroxyethyl)sulfide, 1,2-bis(2-hydroxyethylmercapto)ethane, bis(2-hydroxyethyl)disulfide and 1,4-dithiane-2,5-diol, or sulfur-containing diols having a polyester urethane, polythioester urethane, polyester thiourethane or polythioester thiourethane structure of the type specified in EP-A 1 640 394, can be cited here by way of example.

Low-molecular-weight, hydroxy- and/or amino-functional components, i.e. those in a molecular weight range from 62 to 500, preferably 62 to 400, can also be used as isocyanate-reactive compounds B) in the production of the lightfast polyurethane and/or polyurea compositions according to the invention.

These are in particular simple monohydric or polyhydric alcohols having 2 to 14, preferably 4 to 10 carbon atoms, such as for example 1,2-ethanediol, 1,2- and 1,3-propanediol, the isomeric butanediols, pentanediols, hexanediols, heptanediols and octanediols, 1,10-decanediol, 1,2- and 1,4-cyclohexanediol, 1,4-cyclohexanedimethanol, 4,4′-(1-methylethylidene)-bis-cyclohexanol, 1,2,3-propanetriol, 1,1,1-trimethylolethane, 1,2,6-hexanetriol, 1,1,1-trimethylolpropane, 2,2-bis(hydroxymethyl)-1,3-propanediol, bis-(2-hydroxyethyl)hydroquinone, 1,2,4- and 1,3,5-trihydroxycyclohexane or 1,3,5-tris(2-hydroxyethyl)isocyanurate.

Examples of suitable low-molecular-weight amino-functional compounds are for example aliphatic and cycloaliphatic amines and amino alcohols having primary- and/or secondary-bonded amino groups, such as for example cyclohexylamine, 2-methyl-1,5-pentanediamine, diethanolamine, monoethanolamine, propylamine, butylamine, dibutylamine, hexylamine, monoisopropanolamine, diisopropanolamine, ethylenediamine, 1,3-diaminopropane, 1,4-diaminobutane, isophorone diamine, diethylenetriamine, ethanolamine, aminoethyl ethanolamine, diaminocyclohexane, hexamethylenediamine, methyliminobispropylamine, iminobispropylamine, bis(aminopropyl)piperazine, aminoethylpiperazine, 1,2-diaminocyclohexane, triethylenetetramine, tetraethylenepentamine, 1,8-p-diaminomenthane, bis(4-aminocyclohexyl)methane, bis(4-amino-3-methylcyclohexyl)methane, bis(4-amino-3,5-dimethylcyclohexyl)methane, bis(4-amino-2,3,5-trimethylcyclohexyl)methane, 1,1-bis(4-aminocyclohexyl)propane, 2,2-bis(4-aminocyclohexyl)propane, 1,1-bis(4-aminocyclohexyl)ethane, 1,1-bis(4-aminocyclohexyl)butane, 2,2-bis(4-aminocyclohexyl)butane, 1,1-bis(4-amino-3-methylcyclohexyl)ethane, 2,2-bis(4-amino-3-methylcyclohexyl)propane, 1,1-bis(4-amino-3,5-dimethylcyclohexyl)ethane, 2,2-bis(4-amino-3,5-dimethylcyclohexyl)propane, 2,2-bis(4-amino-3,5-dimethylcyclohexyl)butane, 2,4-diaminodicyclohexylmethane, 4-aminocyclohexyl-4-amino-3-methylcyclohexylmethane, 4-amino-3,5-dimethylcyclohexyl-4-amino-3-methylcyclohexylmethane and 2-(4-aminocyclohexyl)-2-(4-amino-3-methylcyclohexyl)methane.

Examples of aromatic polyamines, in particular diamines, having molecular weights below 500, which are suitable as isocyanate-reactive compounds B), are for example 1,2- and 1,4-diaminobenzene, 2,4- and 2,6-diaminotoluene, 2,4′- and/or 4,4′-diaminodiphenylmethane, 1,5-diaminonaphthalene, 4,4′,4″-triaminotriphenylmethane, 4,4′-bis-(methylamino)diphenylmethane or 1-methyl-2-methylamino-4-aminobenzene, 1-methyl-3,5-diethyl-2,4-diaminobenzene, 1-methyl-3,5-diethyl-2,6-diaminobenzene, 1,3,5-trimethyl-2,4-diaminobenzene, 1,3,5-triethyl-2,4-diaminobenzene, 3,5,3′,5′-tetraethyl-4,4′-diaminodiphenylmethane, 3,5,3′,5′-tetraisopropyl-4,4′-diaminodiphenylmethane, 3,5-diethyl-3′,5′-diisopropyl-4,4′-diaminodiphenylmethane, 3,3′-diethyl-5,5′-diisopropyl-4,4′-diaminodiphenylmethane, 1-methyl-2,6-diamino-3-isopropylbenzene, liquid polyphenyl-polymethylene-polyamine blends, such as are obtainable by known means by condensation of aniline with formaldehyde, and any mixtures of such polyamines. Particular mention can be made in this connection of mixtures of for example 1-methyl-3,5-diethyl-2,4-diaminobenzene with 1-methyl-3,5-diethyl-2,6-diaminobenzene in a weight ratio of 50:50 to 85:15, preferably 65:35 to 80:20.

The use of low-molecular-weight amino-functional polyethers having molecular weights below 500 is likewise possible. These are for example those having primary and/or secondary, aromatically or aliphatically bonded amino groups, in which the amino groups are optionally bonded to the polyether chains via urethane or ester groups and which can be obtained by known methods already described above for producing the higher-molecular-weight amino polyethers.

Sterically hindered aliphatic diamines having two secondary-bonded amino groups can optionally also be used as isocyanate group-reactive components E), such as for example the reaction products of aliphatic and/or cycloaliphatic diamines with maleic acid or fumaric acid esters known from EP-A 0 403 921, the bis-adduct of acrylonitrile with isophorone diamine obtainable according to the teaching of EP-A 1 767 559 or the hydrogenation products of Schiff bases obtainable from aliphatic and/or cycloaliphatic diamines and ketones, such as for example diisopropylketone, described for example in DE-A 19 701 835.

Preferred reaction partners B) for the isocyanate-functional starting components A) are the aforementioned polymeric polyether polyols, polyester polyols and/or amino polyethers, the cited low-molecular-weight aliphatic and cycloaliphatic polyhydric alcohols and the cited low-molecular-weight polyvalent amines, in particular sterically hindered aliphatic diamines having two secondary-bonded amino groups.

Also suitable as reaction partners for the isocyanate-functional starting components A) are any mixtures of the isocyanate group-reactive components B) cited above by way of example. Whereas pure polyurethane compositions are obtained using exclusively hydroxy-functional components B) and pure polyurea compositions are obtained using exclusively polyamines B), the use of amino alcohols or suitable mixtures of hydroxy- and amino-functional compounds as component B) leads to the production of polyurethane ureas, in which the equivalents ratio of urethane to urea groups can be adjusted as required.

Irrespective of the type of starting substances chosen, in the reaction of the polyisocyanate components A) with the isocyanate group-reactive components B) an equivalents ratio of isocyanate groups to isocyanate-reactive groups of 0.5:1 to 2.0:1, preferably 0.7:1 to 1.3:1, particularly preferably 0.8:1 to 1.2:1 is maintained.

In addition to the cited starting components A) and B), further auxiliary agents and additives C), such as for example catalysts, blowing agents, surface-active agents, UV stabilisers, foam stabilisers, antioxidants, release agents, fillers and pigments, can optionally be incorporated.

Conventional catalysts known from polyurethane chemistry can be used for example to accelerate the reaction. Examples cited here by way of example are tertiary amines, such as for example triethylamine, tributylamine, dimethylbenzylamine, diethylbenzylamine, pyridine, methylpyridine, dicyclohexylmethylamine, dimethylcyclohexylamine, N,N,N′,N′-tetramethyldiaminodiethyl ether, bis-(dimethylaminopropyl)urea, N-methyl- or N-ethyl morpholine, N-coco-morpholine, N-cyclohexylmorpholine, N,N,N′,N′-tetramethylethylene diamine, N,N,N′,N′-tetramethyl-1,3-butanediamine, N,N,N′,N′-tetramethyl-1,6-hexanediamine, pentamethyl diethylenetriamine, N-methyl piperidine, N-dimethylaminoethyl piperidine, N,N′-dimethyl piperazine, N-methyl-N′-dimethylaminopiperazine, 1,8-diazabicyclo(5.4.0)undecene-7 (DBU), 1,2-dimethylimidazole, 2-methylimidazole, N,N-dimethylimidazole-β-phenylethylamine, 1,4-diazabicyclo-(2,2,2)-octane, bis-(N,N-dimethylaminoethyl)adipate; alkanolamine compounds, such as for example triethanolamine, triisopropanolamine, N-methyl- and N-ethyl diethanolamine, dimethylaminoethanol, 2-(N,N-dimethylaminoethoxy)ethanol, N,N′,N″-tris-(dialkylaminoalkyl)hexahydrotriazines, for example N,N′,N″-tris-(dimethylaminopropyl)-s-hexahydrotriazine and/or bis(dimethylaminoethyl)ether; metal salts, such as for example inorganic and/or organic compounds of iron, lead, bismuth, zinc and/or tin in conventional oxidation stages of the metal, for example iron(II) chloride, iron(III) chloride, zinc chloride, zinc-2-ethylcaproate, tin(II) octoate, tin(II) ethylcaproate, tin(II) palmitate, dibutyl tin(IV) dilaurate (DBTL), dibutyl dilauryl tin mercaptide, or lead octoate; amidines, such as for example 2,3-dimethyl-3,4,5,6-tetrahydropyrimidine; tetraalkylammonium hydroxides, such as for example tetramethylammonium hydroxide; alkali hydroxides, such as for example sodium hydroxide and alkali alcoholates, such as for example sodium methylate and potassium isopropylate, and alkali salts of long-chain fatty acids having 10 to 20 C atoms and optionally lateral OH groups.

Catalysts C) which are preferably used are tertiary amines and tin compounds of the cited type.

The catalysts cited by way of example can be used in the production of the lightfast polyurethane and/or polyurea compositions according to the invention individually or in the form of any mixtures with one another and are optionally used in amounts of 0.01 to 5.0 wt. %, preferably 0.1 to 2 wt. %, calculated as the total amount of catalysts used relative to the total amount of starting compounds used.

Compact mouldings are preferably produced by the process according to the invention. Through the addition of suitable blowing agents, however, foamed moulded articles can also be produced. Suitable blowing agents for this purpose are for example highly volatile organic substances, such as for example acetone, ethyl acetate, halogen-substituted alkanes, such as methylene chloride, chloroform, ethylidene chloride, vinylidene chloride, monofluorotrichloromethane, chlorotrifluoromethane or dichlorodifluoromethane, butane, hexane, heptane or diethyl ether and/or dissolved inert gases, such as for example nitrogen, air or carbon dioxide.

Water, compounds containing water of hydration, carboxylic acids, tert-alcohols, for example t-butanol, carbamates, for example the carbamates described in EP-A 1 000 955, in particular on page 2, lines 5 to 31 and page 3, lines 21 to 42, carbonates, for example ammonium carbonate and/or ammonium hydrogen carbonate and/or guanidine carbamate are suitable as chemical blowing agents C), i.e. blowing agents which form gaseous products on the basis of a reaction, for example with isocyanate groups. A blowing effect can also be achieved by the addition of compounds which undergo decomposition at temperatures above room temperature with release of gases, for example nitrogen, for example azo compounds such as azo dicarbonamide or azoisobutyric acid nitrile. Other examples of blowing agents and details of the use of blowing agents are described in Kunststoff-Handbuch, volume VII, edited by Vieweg and Hochtlen, Carl-Hanser-Verlag, Munich 1966, for example on pages 108 and 109, 453 to 455 and 507 to 510.

Surface-active additives C) can also additionally be used according to the invention as emulsifiers and foam stabilisers. Suitable emulsifiers are for example the sodium salts of castor oil sulfonates or fatty acids, salts of fatty acids with amines, such as for example oleic acid diethylamine or stearic acid diethanolamine. Alkali or ammonium salts of sulfonic acids, such as for example of dodecyl benzene sulfonic acids, fatty acids, such as for example ricinoleic acid, or polymeric fatty acids, or ethoxylated nonyl phenol can also be incorporated as surface-active additives.

Suitable foam stabilisers are in particular the known, preferably water-soluble polyether siloxanes, as described for example by U.S. Pat. No. 2,834,748, DE-A 1 012 602 and DE-A 1 719 238. The polysiloxane-polyoxyalkylene copolymers branched via allophanate groups which are obtainable in accordance with DE-A 2 558 523 are also suitable foam stabilisers.

The aforementioned emulsifiers and stabilisers which can optionally be incorporated in the process according to the invention can be used both individually and in any combination with one another.

The articles obtained from the polyurethane and/or polyurea compositions which can be produced or used according to the invention are characterised even in their original state, i.e. without the addition of corresponding stabilisers, by very good light resistance. Nevertheless, UV stabilisers (light stabilisers) or antioxidants of the known type can optionally be incorporated during their production as further auxiliary agents and additives C).

Suitable UV stabilisers C) are for example piperidine derivates, such as for example 4-benzoyloxy-2,2,6,6-tetramethylpiperidine, 4-benzoyloxy-1,2,2,6,6-pentamethylpiperidine, bis-(2,2,6,6-tetramethyl-4-piperidyl)sebacate, bis(1,2,2,6,6-pentamethyl-1-4-piperidinyl)sebacate, bis-(2,2,6,6-tetramethyl-4-piperidyl)suberate or bis-(2,2,6,6-tetramethyl-4-piperidyl)dodecanedioate, benzophenone derivatives, such as for example 2,4-dihydroxy, 2-hydroxy-4-methoxy, 2-hydroxy-4-octoxy, 2-hydroxy-4-dodecyloxy or 2,2′-dihydroxy-4-dodecyloxy benzophenone, benzotriazole derivatives, such as for example 2-(2′-hydroxy-3′,5′-di-tert-amylphenyl)benzotriazole, oxalanilides, such as for example 2-ethyl-2′-ethoxy or 4-methyl-4′-methoxy oxalanilide, salicylic acid esters, such as for example salicylic acid phenyl ester, salicylic acid-4-tert-butylphenyl ester and salicylic acid-4-tert-octylphenyl ester, cinnamic acid ester derivatives, such as for example α-cyano-β-methyl-4-methoxycinnamic acid methyl ester, α-cyano-β-methyl-4-methoxycinnamic acid butyl ester, α-cyano-β-phenylcinnamic acid ethyl ester and α-cyano-β-phenylcinnamic acid isooctyl ester, or malonic ester derivatives, such as for example 4-methoxybenzylidene malonic acid dimethyl ester, 4-methoxybenzylidene malonic acid diethyl ester and 4-butoxybenzylidene malonic acid dimethyl ester. These light stabilisers can be used both individually and in any combination with one another.

Suitable antioxidants C) are for example the known sterically hindered phenols, such as for example 2,6-di-tert-butyl-4-methylphenol (ionol), pentaerythritol tetrakis(3-(3,5-di-tert-butyl-4-hydroxyphenyl)propionate, octadecyl-3-(3,5-di-tert-butyl-4-hydroxyphenyl)propionate, triethylene glycol-bis(3-tert-butyl-4-hydroxy-5-methylphenyl)propionate, 2,2′-thio-bis(4-methyl-6-tert-butylphenol), 2,2′-thiodiethyl-bis[3-(3,5-di-tert-butyl-4-hydroxyphenyl)]propionate, which can be used both individually and in any combination with one another.

Other auxiliary agents and additives C) which can optionally be incorporated are for example cell regulators of the type known per se, such as for example paraffins or fatty alcohols, the known flame retardants, such as for example tris-chloroethyl phosphate, ammonium phosphate or polyphosphate, fillers, such as for example barium sulfate, kieselguhr, carbon black, prepared calcium carbonate and also reinforcing glass fibres. Finally, the internal release agents, dyes, pigments, hydrolysis stabilisers, fungistatic and bacteriostatic substances known per se can optionally also be incorporated in the process according to the invention.

The cited auxiliary agents and additives C) which can optionally be incorporated can be added both to the polyisocyanate component A) and/or to the isocyanate group-reactive component B).

To produce the lightfast articles according to the invention from polyurethane and/or polyurea compositions the polyisocyanate component A) is mixed with the isocyanate group-reactive component B), optionally with incorporation of the aforementioned auxiliary agents and additives C), in solvent-free form in the aforementioned NCO/OH ratio with the aid of suitable mixing units and cured by any method, in open or closed moulds, for example by simple casting by hand, but preferably with the aid of suitable machines, such as for example the low-pressure or high-pressure machines conventionally used in polyurethane technology, or by the RIM process, at a temperature of up to 160° C., preferably from 20 to 140° C., particularly preferably from 40 to 100° C., and optionally under elevated pressure of up to 300 bar, preferably up to 100 bar, particularly preferably up to 40 bar.

In order to reduce the viscosity values, the starting components A) and B) can optionally be preheated to a temperature of up to 120° C., preferably up to 100° C., particularly preferably up to 90° C., and optionally degassed by application of a vacuum.

The articles manufactured in this way from the polyurethane and/or polyurea compositions produced or for use according to the invention can generally be demoulded after a short time, for example after a time of 2 to 60 minutes. This can optionally be followed by a post-curing stage at a temperature of 50 to 100° C., preferably 60 to 90° C.

Compact or foamed, light-resistant and weather-resistant rigid articles are obtained in this way from these polyurethane and/or polyurea compositions which are characterised by outstanding optical properties, high resistance to solvents and chemicals and excellent heat resistance, even at elevated temperatures of for example 90° C.

These novel polyurethane and/or polyurea articles are suitable for many different applications, for example for the production of or as glass-substitute windows, such as for example sunroofs, front or rear windscreens or side windows in vehicle or aircraft construction, as safety glass or for the production of spectacle lenses and optical lenses. Owing to their exceptionally high light resistance, in particular also when exposed to hot light, combined with the aforementioned high heat resistance, the polyurethane and/or polyurea compositions obtainable or for use according to the invention are most particularly suitable also for the production of dimensionally stable optical components, for example of lenses or collectors such as are used as secondary lenses in LED lights or car headlamps.

They are moreover also extremely suitable for the transparent casting of optical, electronic or optoelectronic components, such as for example solar modules or light-emitting diodes, wherein in the latter case it is also possible to obtain lens-shaped castings. Furthermore, in combination with suitable blowing agents the polyurethane and/or polyurea compositions which can be used according to the invention also allow the production of articles made from semi-rigid or rigid integral foams which are resistant to yellowing.

### EXAMPLES

Unless otherwise specified, all percentages are based on weight.

The NCO contents were determined by titrimetry in accordance with DIN EN ISO 11909.

OH values were determined by titrimetry by reference to DIN 53240 Part 2, acid values in accordance with DIN 3682.

The residual monomer contents were measured in accordance with DIN EN ISO 10283 by gas chromatography using an internal standard.

All viscosity measurements were performed using a Physica MCR 51 rheometer from Anton Paar Germany GmbH (DE) in accordance with DIN EN ISO 3219.

The Hazen colour number was measured by spectrophotometry in accordance with DIN EN 1557 using a LICO 400 spectrophotometer from Lange, Del.

The glass transition temperature Tg was determined by DSC (differential scanning calorimetry) using a Mettler DSC 12E (Mettler Toledo GmbH, Giessen, Del.) at a heating-up rate of 10° C./min.

Shore hardness values were measured in accordance with DIN 53505 using a Zwick 3100 Shore hardness tester (Zwick, Del.).

CIE Lab values (DIN 6174), yellowness index (ASTM E 313) and transmission measurements were determined using a Lambda 900 spectrophotometer with integrating sphere (150 mm) from Perkin-Elmer, USA (0°/diffuse, reference: air T=100%).

Exposure to xenon light was performed in accordance with DIN EN ISO 11431 in a Suntest CPS (Atlas, USA) with a Suprax daylight filter (UV edge at 290 nm, black panel temperature=48° C.). CIE Lab and ΔE values were determined as a measure of changes in shade.

### Starting Compounds

Polyisocyanate a1-I)

Isocyanurate group-containing HDI polyisocyanate, produced by reference to Example 11 of EP-A 330 966, with the change that 2-ethyl hexanol rather than 2-ethyl-1,3-hexanediol is used as the catalyst solvent.

| | |
|---|---|
| NCO content: | 22.9% |
| NCO functionality: | 3.2 |
| Monomeric HDI: | 0.1% |
| Viscosity (23° C.): | 1200 mPas |

Polyisocyanate a1-II)

HDI polyisocyanate containing isocyanurate and iminoxadiazinedione groups produced by reference to Example 4 of EP-A 0 962 455, by trimerising HDI using a 50% solution of tetrabutylphosphonium hydrogen difluoride in isopropanol/methanol (2:1) as catalyst, terminating the reaction at an NCO content in the crude mixture of 43% by addition of dibutyl phosphate and then separating off the unreacted HDI by film distillation at a temperature of 130° C. and under a pressure of 0.2 mbar.

| | |
|---|---|
| NCO content: | 23.4% |
| NCO functionality: | 3.2 |
| Monomeric HDI: | 0.2% |
| Viscosity (23° C.): | 700 mPas |

Polyisocyanate a1-III)

HDI polyisocyanate containing isocyanurate and allophanate groups, produced in an analogous manner to Example 4 of EP-A 0 496 208.

| | |
|---|---|
| NCO content: | 20.0% |
| NCO functionality: | 2.5 |
| Monomeric HDI: | 0.1% |
| Viscosity (23° C.): | 450 mPas |

Polyisocyanate a1-IV)

HDI polyisocyanate containing isocyanurate and uretdione groups, produced in an analogous manner to Example 1 (comparative example) of EP-B 1 174 428.

| | |
|---|---|
| NCO content: | 21.6% |
| NCO functionality: | 2.4 |
| Monomeric HDI: | 0.2% |
| Viscosity (23° C.): | 160 mPas |

Polyisocyanate a2-I)

Isophorone diisocyanate (IPDI) is trimerised as described in Example 2 of EP-A-0 003 765 until an NCO content of 31.1% is reached and the excess IPDI is removed by film distillation at 170° C./0.1 mbar. An isocyanurate polyisocyanate is obtained as an almost colourless solid resin having a melting range from 100 to 110° C.

| | |
|---|---|
| NCO content: | 16.4% |
| NCO functionality: | 3.3 |
| Monomeric IPDI: | 0.2% |

Polyisocyanate a2-II)

Mixture of an isocyanurate group-containing polyisocyanate based on 4,4′-diisocyanatodicyclohexylmethane with an isocyanurate polyisocyanate based on HDI, produced as described in EP-A 1 484 350 (polyisocyanate A2-II), with a melting range of 75 to 85° C.

| | |
|---|---|
| NCO content: | 15.1% |
| NCO functionality: | 3.5 |
| Monomeric diisocyanates: | 0.2% |

### Production of the Polyisocyanate Components A)

The solid polyisocyanates of type a2) based on cycloaliphatic diisocyanates were coarsely shredded and placed in a reaction vessel at room temperature together with the liquid HDI polyisocyanate of type a1) under an N2 atmosphere. The mixture was heated to 100 to 140° C. in order to dissolve the solid resin and homogenise the mixture and it was stirred until an almost clear solution was obtained. Then it was cooled to 50° C. and filtered through a 200 mu filter.

Table 1 below shows compositions (parts by weight) and characteristics of the polyisocyanates produced in this way.

TABLE 1

| Polyisocyanate | A-I | A-II | A-III | A-IV | A-V |
|---|---|---|---|---|---|
| Polyisocyanate a1 - I) | 70 | — | — | — | 70 |
| Polyisocyanate a1 - II) | — | 60 | — | — | — |
| Polyisocyanate a1 - III) | — | — | 60 | 60 | — |
| Polyisocyanate a1 - IV) | — | — | — | — | — |
| Polyisocyanate a2 - I) | 30 | 40 | 40 | — | — |
| Polyisocyanate a2 - II) | — | — | — | 40 | 30 |
| NCO content [%] | 21.2 | 21.1 | 18.5 | 17.8 | 20.4 |
| NCO functionality | 3.2 | 3.2 | 2.8 | 2.9 | 3.2 |
| Viscosity (23°) [mPas] | 22,500 | 46,000 | 29,700 | 56,200 | 36,250 |

### Hydroxy-Functional Reaction Partner B1)

### Component B1-a)

3112 g (34.6 mol) of 1,3-butanediol, 1863 g (17.9 mol) of neopentyl glycol, 2568 g (19.2 mol) of trimethylolpropane and 6706 g (40.4 mol) of isophthalic acid were weighed together into a reactor fitted with a stirrer, heater, automatic temperature control, nitrogen inlet, column, water separator and receiver and heated to 200° C. whilst stirring and passing through nitrogen such that the temperature at the head of the column did not exceed 102° C. When distillation of the theoretically calculated amount of reaction water (1649 g) was finished the water separator was replaced by a distillation connector and the reaction mixture was stirred at 200° C. until the product had an acid value of ≦5 mg KOH/g. A polyester polyol which was highly viscous at room temperature was obtained with the following characteristics:

| | |
|---|---|
| Flow time (23° C.): | 29 s as a 55% solution in MPA (ISO 2431) |
| OH value: | 335 mg KOH/g |
| Acid value: | 4.7 mg KOH/g |
| Colour number (APHA): | 27 Hazen |
| Average molecular weight: | 435 g/mol (calculated from OH value) |

### Component B1-b)

4034 g (35.4 mol) of ε-caprolactone, 9466 g (70.6 mol) of trimethylolpropane and 6.75 g of tin(II)-2-ethyl hexanoate were mixed together under dry nitrogen and heated for 4 hours at 160° C. After cooling to room temperature a liquid polyester diol was obtained having the following characteristics:

| | | |
|---|---|---|
| Viscosity (23° C.): | 4600 | mPas |
| OH value: | 886 | mg KOH/g |
| Acid value: | 0.4 | mg KOH/g |
| Colour number (APHA): | 42 | Hazen |
| Average molecular weight: | 190 | g/mol (calculated from OH value) |

### Production of the Hydroxy-Functional Reaction Partner B1)

6300 g of component B1-a), 6300 g of component B1-b) and 1400 g of dipropylene glycol were stirred together in a stirred-tank reactor for 1 hour at 60° C. The hydroxy-functional reaction partner B1) was obtained with the following characteristics:

| | | |
|---|---|---|
| Viscosity (23° C.): | 19,900 | mPas |
| OH value: | 628 | mg KOH/g |
| Acid value: | 2.2 | mg KOH/g |
| Colour number (APHA): | 64 | Hazen |
| Average molecular weight: | 243 | g/mol (calculated from OH value) |

### Hydroxy-Functional Reaction Partner B2)

### Component B2-a)

Using the method described for production of the hydroxy-functional reaction partner B1) for component B1-a), a polyester polyol which is highly viscous at room temperature was produced from 3755 g (41.7 mol) of 1,3-butanediol, 2249 g (21.6 mol) of neopentyl glycol, 3099 g (23.1 mol) of trimethylolpropane and 5386 g (55.0 mol) of maleic anhydride, with the following characteristics:

| | |
|---|---|
| Flow time (23° C.): | 22 s as a 55% solution in MPA (ISO 2431) |
| OH value: | 331 mg KOH/g |
| Acid value: | 4.7 mg KOH/g |
| Colour number (APHA): | 23 Hazen |
| Average molecular weight: | 465 g/mol (calculated from OH value) |

### Production of the Hydroxy-Functional Reaction Partner B2)

6750 g of component B2-a), 6750 g of the caprolactone polyester described in the production of the hydroxy-functional reaction partner B1) as component B1-b) and 1500 g of dipropylene glycol were stirred together in a stirred-tank reactor for 1 hour at 60° C. The hydroxy-functional reaction partner B2) was obtained with the following characteristics:

| | | |
|---|---|---|
| Viscosity (23° C.): | 8100 | mPas |
| OH value: | 616 | mg KOH/g |
| Acid value: | 2.3 | mg KOH/g |
| Colour number (APHA): | 64 | Hazen |
| Average molecular weight: | 250 | g/mol (calculated from OH value) |

### Hydroxy-Functional Reaction Partner B3)

Polyether polyol mixture, consisting of equal parts by weight of a polypropylene oxide polyether started on trimethylolpropane, having a hydroxyl value of 1029 mg KOH/g and a viscosity (23° C.) of 8100 mPas, and an ethylene oxide polyether started on trimethylolpropane, having a hydroxyl value of 550 mg KOH/g and a viscosity (23° C.) of 505 mPas.

### Examples 1 to 7

### Production of Potting Compounds

In order to produce potting compounds, polyisocyanate components A) and polyol components B), optionally with incorporation of DBTL as catalyst, in the combinations and proportions (parts by weight) specified in Table 2, corresponding in each case to an equivalents ratio of isocyanate groups to hydroxyl groups of 1:1, were homogenised using a SpeedMixer DAC 150 FVZ (Hauschild, Del.) for 1 min at 3500 rpm and then poured by hand into open, unheated polypropylene moulds. After curing for 30 minutes at room temperature or at 70° C. in a drying oven the specimens (diameter 50 mm, height 5 mm) were demoulded.

After a post-curing time of 24 hours the specimens were tested for their mechanical and optical properties. For a rapid assessment of the heat resistance the Shore hardness was measured on a sample heated to 80° C. and the difference from the Shore hardness of the same sample measured at room temperature was calculated. The test results can likewise be found in Table 2.

As the examples show, the polyisocyanate components A-I to A-V used according to the invention as crosslinkers for potting compounds, both in combination with polyester polyols based on aromatic carboxylic acids (Examples 1 to 5) and in combination with aliphatic polyester polyols (Example 6) and polyether polyols (Example 7), deliver very rigid potting compounds having excellent heat resistance and high optical transparency. Example 6 and the fact that even after being stored for one week at 90° C. the specimen obtained in accordance with Example 7 showed only a negligibly increased yellowness index of 2.2, refute the teaching of EP-A 1 484 350, according to which the combination of such polyisocyanates with aliphatic polyester polyols or polyether polyols generally leads to hazy polyurethanes or to polyurethanes which are not resistant to yellowing.

TABLE 2

| | Example | | | | | | |
|---|---|---|---|---|---|---|---|
| | 1 | 2 | 3 | 4 | 5 | 6 | 7 |
| Polyisocyanate A-I | 69.0 | — | — | — | — | 68.5 | — |
| Polyisocyanate A-II | — | 68.4 | — | — | — | — | 73.0 |
| Polyisocyanate A-III | — | — | 71.1 | — | — | — | — |
| Polyisocyanate A-IV | — | — | — | 71.9 | — | — | — |
| Polyisocyanate A-V | — | — | — | — | 69.1 | — | — |
| Polyol B1) | 31.0 | 30.6 | 27.9 | 27.1 | 29.9 | — | — |
| Polyol B2) | — | — | — | — | — | 31.5 | — |
| Polyol B3) | — | — | — | — | — | — | 26.0 |
| DBTL | — | 1.0 | 1.0 | 1.0 | 1.0 | — | 1.0 |
| Curing temperature | 70 | 23 | 23 | 23 | 23 | 70 | 23 |
| [°C.] | | | | | | | |
| Tg [° C.] | 92 | 106 | 94 | 80 | 95 | 74 | 101 |
| Shore hardness D | 84 | 84 | 79 | 83 | 85 | 82 | 75 |
| Δ Shore hardness D | −7 % | −4% | −1% | −6% | −4% | −6% | −3% |
| (80° C.) | | | | | | | |
| Appearance | clear | clear | clear | clear | clear | clear | clear |
| Yellowness index b | 2.3 | 2.5 | 1.9 | 1.6 | 2.1 | 2.4 | 1.9 |
| ΔE after 400 h | 6.4 | 7.5 | n.d. | n.d. | n.d. | n.d. | n.d. |
| xenon test | | | | | | | |

### Example 8

The potting compound from Example 1 was poured into a heatable mould (195×290×4 mm) using a laboratory metering unit under the conditions specified in Table 3.

TABLE 3
Processing parameters

| | |
|---|---|
| Polyisocyanate A1)^{a)} | 100 parts by wt. |
| Polyol B1)^{a)} | 45 parts by wt. |
| Mould temperature | 70° C. |
| Casting time (approx.) | approx. 360 s |
| Release time (approx.) | approx. 35 min |
| Post-curing (time/temperature) | 12 h/65° C. |

^{a)}Processing temperature in each case 65° C.

Specimens were cut out of the sample sheets obtained in this way and were subjected to further mechanical and thermal tests, the results of which are shown in Tables 4 and 5.

TABLE 4
Mechanical properties

| | |
|---|---|
| Shore hardness D | 84 |
| Density (DIN 53479) | 1.18 g/cm³ |
| Ball indentation hardness (DIN EN 2039-1) | 137 N/mm² |
| Flexural modulus of elasticity (DIN ISO EN 178) | 2330 N/mm² |
| Flexural stress at break (DIN ISO EN 178) | 100 N/mm² |
| Flexural strain at break (DIN ISO EN 178) | 5% |
| Tear strength (tensile test, DIN 53504) | 64 MPa |
| Ultimate elongation (tensile test, DIN 53504) | 2% |
| Puncture test (with lubricant) (DIN EN ISO 6603-2) | 955 N |
| Impact resilience (DIN 53512) | 69% |

TABLE 5
Thermal properties

| | |
|---|---|
| Coefficient of linear thermal expansion (2^{nd} pass) | 88 · 10⁻⁶ l/K |
| (TM900026) | |
| Preferred measuring range: −20 to 120° C. | |
| Coefficient of linear thermal expansion, 2^{nd} pass (ASTM | 80 · 10⁻⁶ l/K |
| E831) | |
| Preferred measuring range up to 55° C. | |
| Coefficient of linear thermal expansion, 2^{nd} pass (ASTM | 69 · 10⁻⁶ l/K |
| D696-91) | |
| Preferred measuring range −30 to 30° C. | |

### Example 9

A specimen produced as described in Example 1 at a sample temperature of 90° C. was exposed to white LED light at a distance of 2 mm. Table 6 shows the changes in transmission, shade of colour (CIE Lab values) and yellowness (yellowness index YI) over the period of exposure to light. The high transparency showing little change over time (˜90% transmission) and the low yellowness in particular demonstrate the excellent suitability of the polyisocyanates according to the invention for the production of elastic potting compounds for the encapsulation of light-emitting diodes.

TABLE 6

| | Exposure time [h] | | |
|---|---|---|---|
| | 0 | 406 | 1936 |
| Ty [%] (D6510°) | 90.48 | 90.05 | 89.92 |
| YI (D6510°) | 1.08 | 0.75 | 0.80 |
| L*(D6510°) | 96.19 | 96.02 | 95.97 |
| a*(D6510°) | −0.12 | −0.03 | −0.02 |
| b*(D6510°) | 0.62 | 0.42 | 0.42 |
| deltaTy | — | −0.43 | −0.56 |
| deltaYI | — | −0.33 | −0.28 |

### Example 10

100 parts by weight of polyol B3), 1.0 part by weight of water, 0.5 parts by weight of DBTL and 0.5 parts by weight of DBU were homogenised using a SpeedMixer DAC 150 FVZ (Hauschild, Del.) for 1 minute at 3500 rpm. The catalysed polyol mixture obtained in this way was introduced together with 50 parts by weight of the polyisocyanate component A-IV, corresponding to an equivalents ratio of isocyanate groups to hydroxyl groups of 1.05:1, into a closed aluminium mould heated to 70° C. and measuring 10×250×350 mm, whose inner walls were treated with a non-silicone-based release agent Acmos 30-2411 (Acmos Chemie KG, DE), by means of a laboratory two-component metering-mixing unit and compacted to a density of 0.6 g/cm³. The free density of the foam was 0.220 g/cm³. The processing times for the reaction mixture were as follows: cream time=20 s, setting time=50 s. After 10 minutes the part was released and was stored for a further 24 h at 23° C.

An aliphatic integral foam was obtained having a compact skin closed on all sides and an overall density of 0.608 g/cm³, a Shore hardness D of 60 and a Tg of 92° C. The moulding showed no signs of softening after being stored for one hour at 90° C.

1.-18. (canceled)

19. A lightfast compact or foamed polyurethane and/or polyurea article produced with solvent-free polyisocyanate components A) having a viscosity of 2000 to 100,000 mPas at 23° C., an isocyanate group content of 13 to 23 wt. % and an average isocyanate functionality of at least 2.5, wherein the solvent-free polyisocyanate components consist of
a1) 30 to 95 wt. % of at least one polyisocyanate based on hexamethylene diisocyanate having an NCO content of 16 to 24 wt. % and
a2) 5 to 70 wt. % of at least one polyisocyanate based on cycloaliphatic diisocyanates having an NCO content of 10 to 22 wt. %.

20. The lightfast compact or foamed polyurethane and/or polyurea article according to claim 19, wherein the solvent-free polyisocyanate components A) has a viscosity at 23° C. of 6000 to 60,000 mPas, an isocyanate group content of 15 to 22 wt. % and an average isocyanate functionality of 2.8 to 5.0.

21. The lightfast compact or foamed polyurethane and/or polyurea article according to claim 19, wherein the at least one polyisocyanate based on hyexamethylene diisocyanate comprises hexamethylene diisocyanate derivatives having allophanate, biuret, isocyanurate, iminooxadiazinedione, oxadiazinetrione, uretdione and/or urethane groups, and wherein the at least one polyisocyanate based on hyexamethylene diisocyanate has a viscosity at 23° C. of 80 to 4000 mPas, an isocyanate group content of 16 to 24.5 wt. % and an average isocyanate functionality of at least 2.0.

22. The lightfast compact or foamed polyurethane and/or polyurea article according to claim 19, wherein the at least one polyisocyanate based on cycloaliphatic diisocyanates comprises isocyanurate group-containing polyisocyanates based on isophorone diisocyanate and/or 2,4′- and 4,4′-diisocyanatodicyclohexylmethane having an isocyanate group content of 13 to 19 wt. %.

23. The lightfast compact or foamed polyurethane and/or polyurea article according to claim 19, wherein the article is a glass substitute.

24. The lightfast compact or foamed polyurethane and/or polyurea article according to claim 19, wherein the article is a window for vehicles or aircrafts.

25. The lightfast compact or foamed polyurethane and/or polyurea article according to claim 24, wherein the window is a sunroof, front or rear windscreen or a side window for vehicles or aircrafts.

26. The lightfast compact or foamed polyurethane and/or polyurea article according to claim 19, wherein the article is safety glass.

27. The lightfast compact or foamed polyurethane and/or polyurea article according to claim 19, wherein the article is an optical lens or spectacle lens.

28. The lightfast compact or foamed polyurethane and/or polyurea article according to claim 19, wherein the article is a transparently cast optical, optoelectronic or electronic component.

29. The lightfast compact or foamed polyurethane and/or polyurea article according to claim 28, wherein the transparently cast optical, optoelectronic or electronic component is a solar module.

30. The lightfast compact or foamed polyurethane and/or polyurea article according to claim 28, wherein the transparently cast optical, optoelectronic or electronic component is a light-emitting diode.

31. The lightfast compact or foamed polyurethane and/or polyurea article according to claim 19, wherein the article is a rigid or semi-rigid integral foam.

32. A process for the production of lightfast polyurethane and/or polyurea articles by solvent-free reaction of
A) a polyisocyanate component having a viscosity at 23° C. of 2000 to 100,000 mPas, an isocyanate group content of 13 to 23 wt. % and an average isocyanate functionality of at least 2.5, wherein the polyisocyanate component consists of
a1) 30 to 95 wt. % of at least one polyisocyanate based on hexamethylene diisocyanate having an NCO content of 16 to 24 wt. % and
a2) 5 to 70 wt. % of at least one polyisocyanate based on cycloaliphatic diisocyanates having an NCO content of 10 to 22 wt. %,
with
B) reaction partners having an average functionality of 2.0 to 6.0 which are reactive to the isocyanate groups of the polyisocyanate component, and optionally with incorporation of
C) further auxiliary agents and/or additives,
wherein an equivalents ratio of isocyanate groups to isocyanate-reactive groups of 0.5:1 to 2.0:1 is maintained.

33. The process according to claim 32, wherein the reaction partners comprise hydroxy-, amino- and/or mercapto-functional compounds having an average molecular weight of 62 to 12,000.

34. The process according to claim 32, wherein the reaction partners comprise polyether polyols, polyester polyols, polycarbonate polyols and/or amino polyethers having an average molecular weight of 500 to 12,000; and/or polythioether thiols, polyester thiols and/or low-molecular-weight hydroxy- and/or amino-functional components having an average molecular weight of 62 to 500.

35. The process according to claim 32, wherein the further auxiliary agents and/or additives comprise water as a blowing agent.

36. The process according to claim 32, wherein the reaction of the polyisocyanate component with the reaction partners is performed at a temperature of up to 160° C. and under a pressure of up to 300 bar.
